(19) United States
(12) Patent Application Publication
(10) Pub. No.: US 2006/0115409 A1
(43) Pub. Date: Jun. 1, 2006

(54) Method for producing carbon nanotube

(76) Inventors: Yuan-Yao Li, Min-Hsiung (TW); Chao-Wei Huang, Fengyuan City (TW)

Correspondence Address: LIN & ASSOCIATES INTELLECTUAL PROPERTY, P.O. BOX 2339, SARATOGA, CA, 95070-0339, US

(21) Appl. No.: 10/998,253

(22) Filed: Nov. 26, 2004

(51) Int. Cl. D01F 9/12; C01B 31/00

(52) U.S. Cl. 423/447.1; 264/29.7

(57) ABSTRACT

Disclosed is a method for producing carbon nanotubes, which uses a polymer as a raw material to undergo in situ thermal decomposition. The method includes steps of mixing the polymer and metallic catalyst through in situ thermal decomposition to carbonize the polymer and release carbon elements to produce carbon nanotubes. Advantages of the present invention include easy to prepare, low temperature in manipulation, low production cost, and high safety.

### BACKGROUND OF THE INVENTION

1. Field of the Invention

The present invention relates to a method for producing carbon nanotubes (CNTs). Especially, the present invention relates to a method performing in-situ thermal decomposition of polymers to produce carbon nanotubes.

2. The Prior Arts

Nanotechnology is one of the most important top technologies in this century, which is also a science technology evoked by new industrial revolution. This emerging technique is attractive at present and is gradually displayed in an attitude of changing the basic research fields of information technology, biological science, environmental science, energy source, material science and so on. The trend of industrial elements toward small features, high density, fast transmission, low energy cost and high production rate results in the further needs of element materials. Therefore, nanomaterial containing nanostructure becomes the best material to fulfill the abovementioned needs. Recently, nanomaterials gradually become arresting, one of the most bodacious, being broadly discussed and applied material is carbon nanotubes.

Since their discovery in nineties, carbon nanotubes have been attracting much attention due to their special cylinder like structure constructed of hexagonal array, as well as the unique electrical, magnetic, optic characteristics and the potential applications. The fields of carbon nanotube applications include photo-electric elements, electric elements, biomedical science, energy materials, and artificial diamonds, etcetera. International technology and industry are all emphasized on this technology without regard to countries or research fields, such as IBM Company and NASA in USA, NEC and Shawa Denko Companies in Japan, and Max-Planck Institute in Germany are focused very broad and deep in the field of carbon nanotubes and their applications. The reports on new research of carbon nanotubes are competing internationally.

On the other hand, due to high aspect ratio and small tip radii of curvature, carbon nanotubes are very suitable for electron field emission; Carbon nanotube materials are alternatives to conventional metallic microtips in field emission display (FED) application for high luminance and efficiency. In the application of recording media, carbon nanotubes can be used in recording head with memory of terabyte scale (1 Terabyte=1,000 Megabyes). Moreover, carbon nanotubes are the basic materials of other nanostructures, such as the synthesizing templates of nanowire and nanorod.

The existing production methods of carbon nanotubes include arc discharge, chemical vapor deposition (CVD), pulsed laser deposition, plasma enhanced CVD, microwave plasma CVD and laser ablation and so on, among which arc discharge and chemical vapor deposition are commonly used. These two methods need high temperatures (typically more than 1000° C.), high production cost, and the starting procedures and process procedures are more complex and with higher risk. Accordingly, it is desirable to develop an improved method of producing carbon nanotubes, which process is operated easily, performed at low working temperature and has high safety to eliminate above-mentioned problems in the prior arts.

### SUMMARY OF THE INVENTION

A primary object of the present invention is to provide a method for production of carbon nanotubes, which is advantageous for simplifying the production process and lowering the production cost.

Another object of the present invention is to provide a method for lowering the reaction temperature, and not adding hydrocarbon gas for fabricating carbon nanotubes to lower the risk of carbon nanotubes production.

Yet another object of the invention is to provide a carbon nanotube producing method that uses in-situ thermal decomposition to synthesize carbon nanotubes in desired sites and be applied in production of advanced nano-device.

To accomplish and fulfill the abovementioned objects of the present invention, in-situ thermal decomposition is used to produce carbon nanotubes. The present invention uses a polymer as a carbon source, and mixes the polymer with a metallic catalyst to proceed in situ decomposition. Solvent removement, hydrogen removement, thermal decomposition, carbonization and graphitization in the mixture are performed with a rising high temperature. The polymer reacts with the metallic catalyst to release carbons and produce carbon nanotubes.

The existing production methods are disadvantageous for their high working temperatures, high production cost, complicated procedures and higher risk. Contrary to the prior art, the present invention provides a method using in-situ thermal decomposition to synthesize carbon nanotubes, which is simple and safe in the production process and without the drawbacks mentioned above.

The advantages of the method using in-situ thermal decomposition to produce carbon nanotubes are summarized as follows:
(1) The carbon source is obtained from the decomposed polymers but not from added hydrocarbons (such as methane and ethane, and so on).
(2) Heating process is completed in a lower temperature (400-1000° C.) to prepare carbon nanotubes.

The abovementioned and other purposes of the present invention, characteristics and advantages will be obvious and clear after referring to the detailed description, preferred embodiment and the attached figures.

### BRIEF DESCRIPTION OF THE DRAWINGS

The related drawings in connection with the detailed description of the present invention to be made later are described briefly as follows, in which:

FIG. 1 shows a flow chart of a method for producing carbon nanotubes in accordance with a preferred embodiment of the present invention.

FIG. 2 A shows a schematic cross section of a polymer film before heating in carbon nanotubes producing procedures according to FIG. 1

FIG. 2 B shows a schematic cross section illustration of a polymer film after heating in carbon nanotubes producing procedures according to FIG. 1.

FIG. 3 shows a scanning electron micrograph (SEM) of carbon nanotubes produced according to the present invention.

FIG. 4 shows a transmission electron micrograph (TEM) of carbon nanotubes produced according to the present invention.

### DETAILED DESCRIPTION OF THE PREFERRED EMBODIMENT

### Example 1

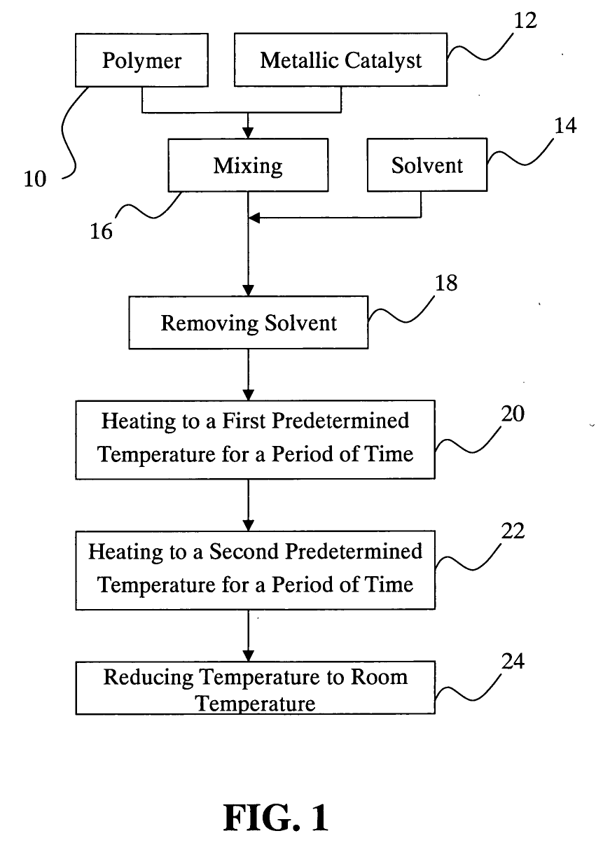

FIG. 1 shows a flow chart of preferred example in carbon nanotubes producing method according to the present invention. Procedures provided in the method include:

In a mixing step (16), polymer (10) and metallic catalyst (12) are mixed thoroughly with solvent (14) (for examples, organic solvent or water). After solvent removing step (18), mixture of polymer (10) and metallic catalyst (12) is obtained. Alternatively, a mixture of polymer and metallic catalyst is heated to a temperature above the melting point of the polymer to become into liquid form, and the metallic catalyst is dispersed uniformly in the polymer, which is not shown in the figure.

The example of polymer (10) applied in the present invention may be polyethylene glycol (PEG), but is not limited to it.

The preferred metallic catalysts used in the present invention are metallic particles or metallic compounds. For example, the metallic particles may be iron, cobalt, or nickel; and the metallic compounds may be compounds of iron, cobalt, or nickel, or salts of iron, cobalt, or nickel and so on. Especially, examples of the metallic compounds include, but not limited thereto, ferrosoferric oxide (Fe₃O₄), ferric oxide (Fe₂O₃), ferric sulfate (Fe₂(SO₄)₃), ferric hydroxide (FeO(OH)), ferric nitrate (Fe(NO₃)₃), nickel nitrate (Ni(NO₃)₂), nickel sulfate hexahydrate (NiSO₄.6H₂O)), or cobalt nitrate hexahydrate (Co(NO₃)₂.6H₂O)) and so on.

The amount of metallic catalysts used to obtain carbon nanotubes of better quality is preferably 0.05 to 10% (w/w) based on the amount of polymer used, and more preferably 0.1 to 1% (w/w). On the other hand, there is no limitation to remove solvent used in the mixing step. Any methods known to remove solvents from solution mixture can be applied in the present invention, for example, evaporating the solvent by heating. In addition, the mixture can be made in forms of film, powder, arrays or bulk as needed before removing the solvent. The application fields of carbon nanotubes can be broadened because the mixture can be shaped into the desired forms corresponding to various usages.

Then, a first heating stage is performed by heating the mixture to a first predetermined temperature for a period of time, step (20), to dehydrogenate and remove undesired evaporating products. The heating temperature of the first heating stage is preferably between 200-400° C., and more preferably between 250-350° C. The heating rate from room temperature to the first predetermined temperature is not particularly specified. However, to make carbon nanotubes of higher quality, the heating rate from room temperature to the first predetermined temperature is preferably at 0.5 to 20° C. per minute, more preferably at 2 to 5° C. per minute. And the heating time under the predetermined heating temperature is preferably 0.5 to 10 hours, more preferably 1 to 5 hours.

A second heating stage is carried out by heating the mixture to a second predetermined temperature for a period of time, step (22), after the first heating stage to allow polymers to process thermal decomposition. At this moment, the bondage structures between polymer molecules are broken, hydrogen and oxygen atoms are free from the polymer structures, and carbon elements are obtained. Finally, the temperature is reduced to room temperature, step (24), to obtain carbon nanotubes with inert gas flowed. The second predetermined temperature is preferably between 400-1000° C., and more preferably between 600-800° C. The heating rate from the first predetermined temperature to the second predetermined temperature, and the heating period after reaching the second predetermined are not particularly specified. However, to make carbon nanotubes of higher quality, the heating rate from the first predetermined temperature to the second predetermined temperature is preferably carried out at 0.5 to 20° C. per minute, more preferably at 2 to 5° C. per minute, which can be the same or different from that of the first stage. And the heating period after reaching the second predetermined temperature is preferably 0.5 to 10 hours, more preferably 1-5 hours.

In addition, the reaction chamber is filled with an inert gas to avoid other undesired reactions, preferrably. Examples of the inert gas comprise, but not limited thereto, nitrogen (N₂), helium (He), argon (Ar), and so on. In order to obtain high yield of carbon nanotubes, before raising temperature to the first predetermined during thermal decomposition, the air is filled into the chamber and then replaced with the inert gas.

The producing method of the present invention is based on multiple stages with various heating temperatures during polymer thermal decomposition. A first thermal decomposition is carried out at a lower temperature, and then another stage of thermal decomposition at a higher temperature is performed, which produces carbon nanotubes with better quality and be more homogenous.

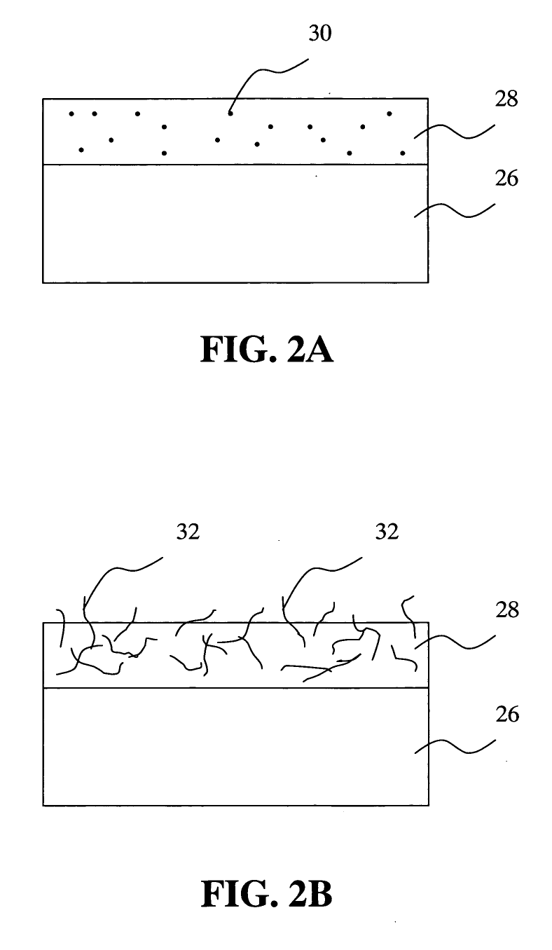

FIG. 2 A and FIG. 2 B show a schematic cross section illustration of carbon nanotube produced by a polymer film before and after heating according to FIG. 1, respectively.

As shown in FIG. 2 A, a thin film (28) containing the mixture of polymer and metallic catalyst (30) is spread on a base plate (26). The polymer is selected from PEG, and metallic catalyst (30) is metallic particle or metallic compound. Examples of the former are iron, cobalt, nickel; and the latter may be compounds of iron, cobalt, and nickel, or salts of iron, cobalt, nickel, and so on. Specifically, the metallic compounds may be Iron(II, III) oxide (Fe₃O₄), Iron(III) oxide (Fe₂O₃), ferric sulfate (Fe₂(SO₄)₃), ferric hydroxide (FeO(OH)), ferric nitrate (Fe(NO₃)₃), nickel nitrate (Ni(NO₃)₂), nickel sulfate hexahydrate (NiSO4.6H₂O)), or cobalt nitrate hexahydrate (Co(NO₃)₂.6H₂O)). The amount of metallic catalyst used is preferably 0.05 to 10% (w/w) based on the amount of polymer used. In addition, the material of base plate needs to be thermal resistant and inertia material, such as silicon chip, aluminum oxide board, silicon board, silicon dioxide board.

As shown in FIG. 2B, carbon nanotubes (32) fabricated in the thin film of the base plate (26) are highly regular in size and quality after abovementioned heating steps during thermal decomposition.

The carbon nanotubes producing method through in situ thermal decomposition can be carried out in temperature below 1000° C. (in comparison to Chemical Vapor Deposition and electric arc discharge), and uses polymer as carbon source at low cost, which makes the production cost relatively and effectively reduced. Moreover, only use of inert gas, no additional hydrocarbon compounds (for example, methane and ethane), low working temperature, no need of high voltages offer increased safety to a large extent. In addition, the present invention uses the decomposed polymers but not adding hydrocarbons as carbon sources, and performs multiple heating stages to produce carbon nanotubes that may be many different forms, such as bamboo-like carbon nanotubes (bamboo-like CNTs), multi-walled carbon nanotubes (MWNTs), spiral carbon nanotubes (spiral CNTs).

The present invention produces carbon nanotubes having diameters ranging between 20 nm to 60 nm, and length is about several micrometers (μm). Observed by transmission electron microscopy (TEM) image reveals that the carbon nanotubes prepared according to the present invention have a hollowed multi-walled structure.

### Example 2

Polyethylene glycol is mixed with ferric sulfate, which amount is 0.1-1% (w/w) based on the amount of polyethylene glycol. Later, a solvent (for example, organic solvent or water) is added to make the two components mixed uniformly. The solvent is removed later to have a uniform mixture of polymer and metallic catalyst.

The abovementioned polymer mixture is spread over an inert plate, such as plate of aluminum oxide, silicon wafer, and silicon dioxide, which is dried to a constant weight thereafter.

The base plate spread with polymer mixture is put into a high temperature stove heated to a predetermined temperature to proceed thermal decomposition. First, the chamber is filled with air, and heated at a rate of 0.5-20° C. per min till the first predetermined temperature (about 200-400° C.) of the first stage, and stayed for 1 to 5 hours at the temperature. Before the first stage of heating, the inert gas (such as nitrogen (N2), helium (He), neon (Ne), or argon (Ar)) is filled into the chamber to replace the air. After the first heating stage, the heating rate of 0.5-20° C. per min is again employed to the second predetermined temperature (about 600-800° C.) of the second stage. The heating time of the second stage is 1 to 5 hours for thermal decomposition to fabricate carbon nanotubes.

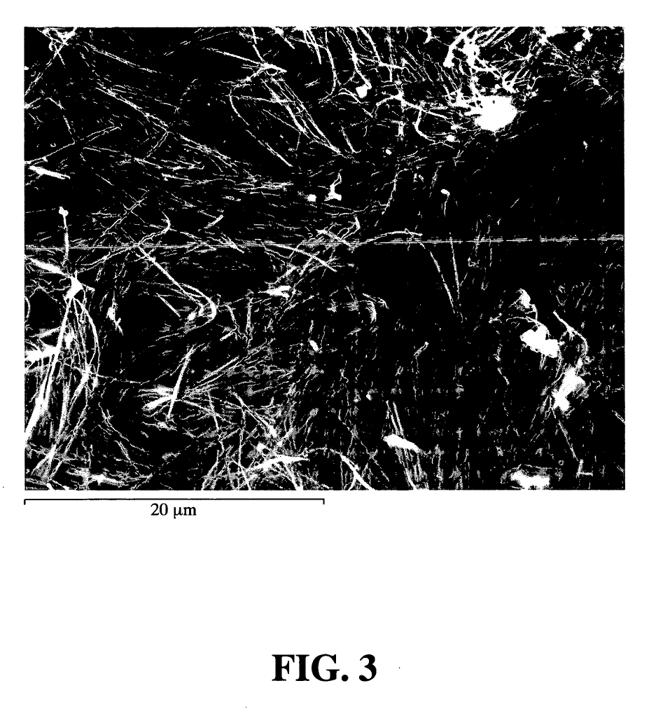

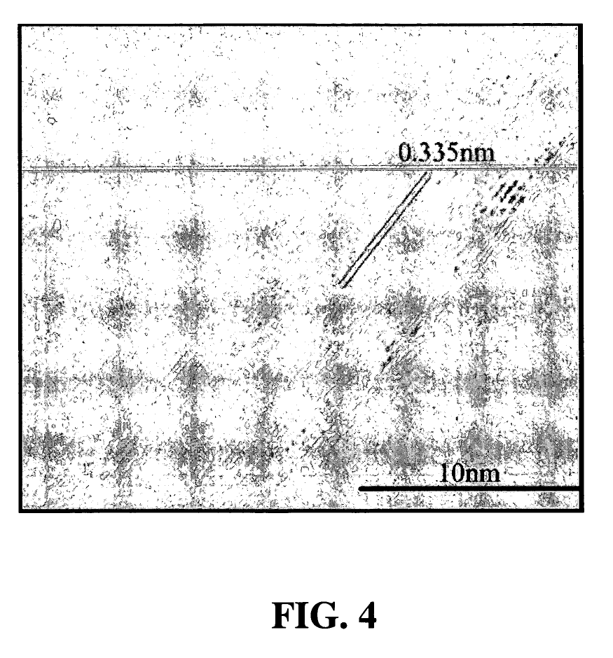

The images of the abovementioned thermal decomposed products is observed and analyzed with a scanning electron microscope (SEM) and a transmission electron microscope (TEM), as shown in FIG. 3 and FIG. 4.

From the abovementioned descriptions and the figures of FIG. 3 and FIG. 4, it is clear that the carbon nanotubes producing method according to the present invention is easy and safer to prepare, works in low temperature, which also prepares carbon nanotubes with good quality.

What is claimed is:

1. A method for preparing carbon nanotubes comprising the steps of:
(a) mixing uniformly a polymer and a metallic catalyst with a solvent to become a mixture;
(b) shaping the mixture into a desired form and drying the mixture after removing the solvent;
(c) heating the dried mixture with a multiple heating stage process comprising a first predetermined temperature of 200-400° C. and a second heating stage at a second predetermined temperature of 400-1000° C. of various heating temperatures to carry out thermal decomposition; and
(d) cooling to room temperature.

2. The method as claimed in claim 1, wherein the polymer comprises polyethylene glycol.

3. The method as claimed in claim 1, wherein the solvent comprises organic solvent or water.

4. The method as claimed in claim 1, wherein the metallic catalyst is selected from the group consisting of iron, cobalt and nickel.

5. The method as claimed in claim 1, wherein the metallic catalyst is selected from the group consisting of compounds of iron, cobalt and nickel.

6. The method as claimed in claim 5, wherein the metallic catalyst is selected from the group consisting of Fe₃O₄ and Fe₂O₃, FeO(OH).

7. The method as claimed in claim 1, wherein the metallic catalyst is selected from the group consisting of salts of iron, cobalt, and nickel.

8. The method as claimed in claim 7, wherein the metallic catalyst is selected from the group consisting of Fe₂(SO₄)₃, Fe(NO₃)₃, Ni(NO₃)₂.6H₂O, NiSO₄.6H₂O, and Co(NO₃)₂.6H₂O.

9. The method as claimed in claim 1, wherein an amount of metallic catalyst used is 0.05-10% based on the polymer used.

10. The method as claimed in claim 1, wherein the mixture is shaped into a form of an array.

11. The method as claimed in claim 1, wherein the mixture is shaped into a form of a thin film.

12. The method as claimed in claim 1, wherein the mixture is shaped into a form of a block.

13. The method as claimed in claim 1, wherein step (c) further comprises a step of filling a reaction chamber with a gas.

14. The method as claimed in claim 13, wherein the gas comprises an inert gas.

15. The method as claimed in claim 14, wherein the inert gas is selected from the group consisting of nitrogen, helium, neon and argon.

16. The method as claimed in claim 13, wherein the gas filling step comprises the steps of filling the reaction chamber with air before heating to the first predetermined temperature in the first stage, and replacing the air with an inert gas after reaching the first predetermined temperature.

17. The method as claimed in claim 16, wherein the inert gas is selected from the group consisting of nitrogen, helium, neon and argon.

18. The method as claimed in claim 1, wherein a heating time at the first predetermined temperature in the first heating stage is between 0.5 to 10 hours.

19. The method as claimed in claim 1, wherein a heating time at the second predetermined temperature in the second heating stage is between 0.5 to 10 hours.

20. The method as claimed in claim 1, wherein a heating rate from room temperature to the first predetermined temperature is 0.5 to 20° C. per minute.

21. The method as claimed in claim 1, wherein a heating rate from room temperature to the second predetermined temperature 0.5 to 20° C. per minute.

22. The method as claimed in claim 1, wherein the carbon nanotubes is selected from the group consisting of bamboo-like carbon nanotubes, multi-walled carbon nanotubes (MWNT) and spiral carbon nanotubes.
